(19) United States
(12) Patent Application Publication
(10) Pub. No.: US 2003/0070665 A1
(43) Pub. Date: Apr. 17, 2003

(54) Pencil ignition coil having retention and tactile feel insertion features

(76) Inventors: Mark Albert Paul, Fishers, IN (US); Harry Oliver Levers JR., Muncie, IN (US); Steve T. Kowalke, Evanston, IL (US)

Correspondence Address: MARGARET A. DOBROWITSKY, DELPHI TECHNOLOGIES, INC., Legal Staff, P.O. Box 5052, Mail Code: 480-414-420, Troy, MI, 48007-5052, US

(21) Appl. No.: 09/982,043

(22) Filed: Oct. 17, 2001

(51) Int. Cl. H01F 27/02

(52) U.S. Cl. 123/635; 123/634; 336/96

(57) ABSTRACT

A “pencil” ignition coil includes a seal member having features that cooperate with complementary features provided on the engine cam cover/spark plug well into which the coil is inserted to provide a retention and tactile feel insertion feature. In particular, the cooperating features are configured to longitudinally align and position the ignition coil in the spark plug well in a predetermined relationship. In one embodiment, the seal member includes a circumferentially-extending rib on an outside diameter thereof, while the cam cover/spark plug well includes an undercut groove portion on an inside diameter portion thereof. The rib has an increased diameter relative to the surrounding, outside diameter surface of the seal member, while the undercut groove portion has an increased diameter relative to the surrounding land portions. Accordingly, when the ignition coil is inserted through an opening portion of the spark plug well of an internal combustion engine, the rib seats in the groove to provide a tactile feel insertion feature, as well as provide a retention function, thereby eliminating the need for a conventional bracket and bolt.

### BACKGROUND OF THE INVENTION

1. Technical Field

The present invention relates generally to an ignition apparatus, and, more particularly, to an ignition apparatus having retention and tactile feel insertion features..

2. Description of the Relate Art

Ignition coils utilize primary and secondary windings and a magnetic circuit. The magnetic circuit may include a central core formed of magnetically permeable material and a side core or shield, as seen by reference to U.S. Pat. No. 6,005,646 issued to Sakamaki et al. Sakamaki et al. disclose an ignition coil having a relatively slender configuration adapted for mounting directly above a spark plug in a spark plug well—commonly referred to as a “pencil” coil. The spark plug well tube is typically very small in diameter, requiring that the conventional ignition coil fit inside. Assembling the coil into the engine conventionally is done by inserting it in the spark plug well and securing it thereto with a bolt through a bracket.

There are, however, problems with assembling a pencil coil into the spark plug well of an engine at, for example, an engine assembly plant. One problem is that there is no positive feedback or tactile feel to indicate when the ignition coil has been inserted far enough into the spark plug well so that a high voltage connector thereof is seated suitably on the spark plug. A second problem is that once the ignition coil has been installed (and, presumably, properly seated), a bracket and a bolt needs to be used to hold the ignition coil in place. The bracket and bolt add material costs, labor costs, and complexity in the design of the ignition coil and, in addition, add a further assembly step.

One approach taken in the art to facilitate assembly is to provide a clip type feature at a high voltage end of the ignition coil so that upon insertion, the ignition coil assembly will “snap” onto the spark plug. However, this type of retention feature is difficult to design and implement due to the stack up tolerances of such a clip type feature as part of the ignition coil as a whole.

Sakamaki et al. referred to above further disclose a seal cover made of rubber which is fitted on the coil case near the top of the ignition coil and is in contact with the cylinder head of the engine when inserted in the spark plug well. The seal cover is disclosed as sealing the open end of the cylindrical bore (i.e., the well) when the ignition coil is inserted. Sakamaki et al. further disclose that the seal cover also serves as a centering member for aligning (i.e., radially aligning) the ignition coil case when it is mounted in the spark plug well. The seal cover has a radially outwardly protruding projection for aligning the ignition coil by abutting it against an inner wall of the cylindrical bore (i.e., spark plug well). However, Sakamaki et al. do not disclose any means for aligning the ignition coil longitudinally (i.e., with respect to the longitudinal length of the spark plug well) so as to properly seat the ignition coil on the spark plug, and further to provide some indication of such proper seating to the installer. Sakamaki et al. also disclose a conventional bracket and bolt associated with the ignition coil for retaining the same to the engine. Sakamaki et al. therefore do not provide any retention improvements in this regard.

There is therefore a need to provide an improved ignition apparatus that minimizes or eliminates one or more of the shortcomings set forth above.

### SUMMARY OF THE INVENTION

An ignition coil assembly in accordance with the present invention provides the means for producing a tactile feel, for example, to an installer when the ignition coil assembly is seated properly, and, further, to hold or retain the ignition coil assembly in place without the need for a bracket and retaining bolt. Another advantage of the present invention is that it provides the function of a vibration damper to isolate the ignition coil assembly from harsh engine vibrations, thereby reducing vibration-related failures in the field. Elimination of the mounting structure not only reduces material cost, and assembly (i.e., labor) cost, but also reduces the ignition coil's mass, and eliminates the need for a mounting boss to be manufactured into the engine (e.g., in the cam cover).

An ignition coil assembly in accordance with the present invention is configured for insertion through a cam cover into a spark plug well of an internal combustion engine. The ignition coil assembly is generally cylindrical-shaped having a main axis, the assembly comprises a transformer portion for generating a spark voltage on a high-voltage (HV) connector located at a first end of the coil, and a seal member. The seal member is disposed at a second end of the ignition coil opposite the first end. The seal member and the cam cover and/or spark plug well have cooperating features configured to longitudinally align and position the ignition coil in the spark plug well in a predetermined relationship. In a further, preferred embodiment, the cooperating features provide for both retention, as well as for producing a tactile feel when the ignition coil is inserted in the spark plug well to the desired longitudinal depth (i.e., such that a rib feature is seated in an undercut groove feature).

### BRIEF DESCRIPTION OF THE DRAWINGS

The present invention will now be described by way of example, with reference to the accompanying drawings, in which:

FIG. 1 is a partial section view, with portions broken away, of an ignition coil assembly in accordance with the present invention;

FIG. 2 is a partial, simplified section view of a first preferred embodiment of the present invention illustrating a seal member and a spark plug well configured to have retention and tactile feel insertion features;

FIG. 3 is a partial, simplified section view of a second preferred embodiment of the present invention illustrating a seal member and a spark plug well configured to have retention and tactile feel insertion features; and

FIG. 4 is a partial section view of an ignition coil suitable for use in the ignition apparatus of FIG. 1.

### DETAILED DESCRIPTION OF THE PREFERRED EMBODIMENTS

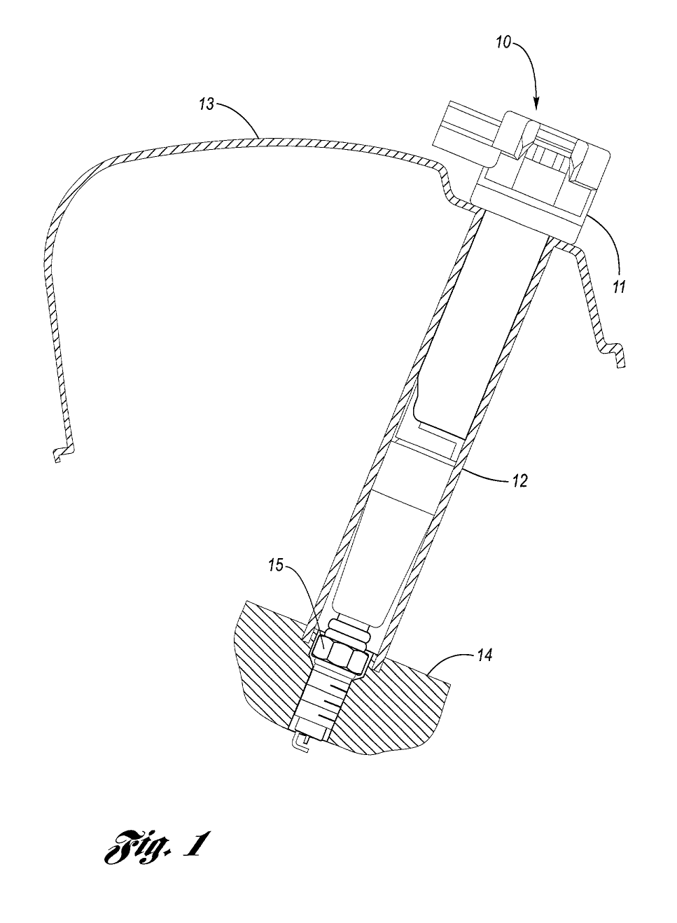

Referring now to the drawings wherein like reference numerals are used to identify identical components in the various views, FIG. 1 shows a complete ignition coil assembly 10, which comprises an ignition coil 11 and which is shown in an inserted position in a spark plug well 12. In the illustrated embodiment, well 12 extends between a cam cover 13 and an engine head portion 14 of an internal combustion engine. Depending on engine design, however, the extent of the spark plug well 12 may vary. Moreover, cam cover 13 may be unitary, or separate pieces. Moreover, it is also known to form the spark plug well directly in a cylinder head. All such variations are considered within the spirit and scope of the invention. A conventional spark plug 15 is also shown.

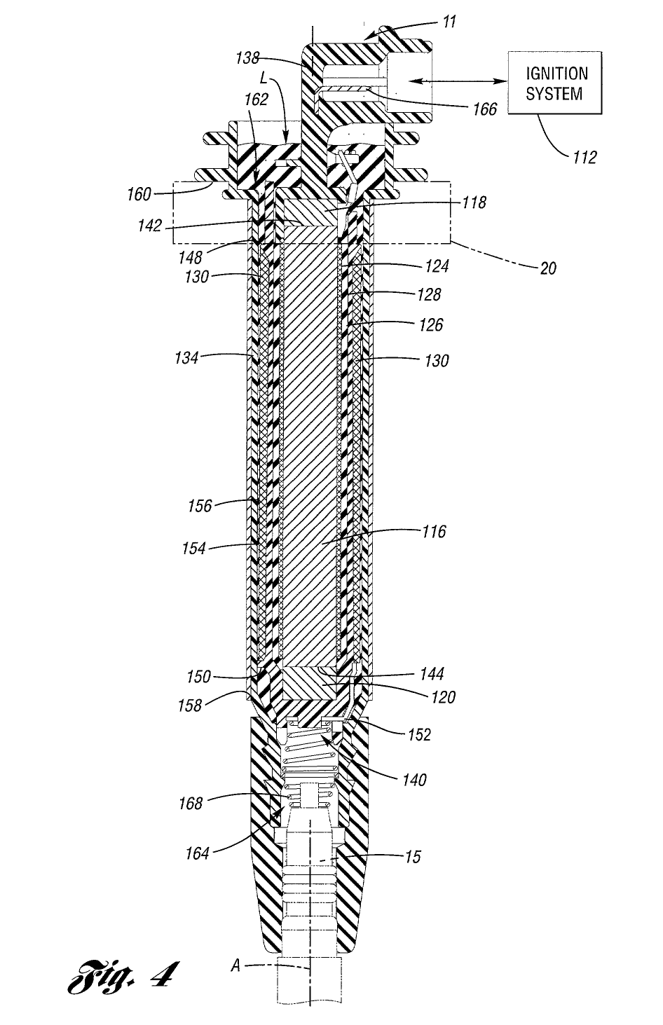

With continued reference to FIG. 1, ignition coil 11 may generally comprise conventional components assembled in accordance with conventional construction techniques. An exemplary coil 11 suitable for use in the present invention is described in detail in connection with FIG. 3. In short, however, coil 11 is generally cylindrical and has a main axis (“A” in FIG. 3) and is configured to be attached directly to a spark plug (i.e., coil 11 is a “pencil” coil). Coil 11 is of the type including a high-voltage transformer having a generally cylindrical central core, a primary winding, and a secondary winding. Coil 11 further includes a case. The central core is a first portion of a complete magnetic circuit and is disposed inside coil 11. Conventionally, a side core or shield formed of magnetically permeable material is disposed radially outwardly of the central core and windings, is coupled to the outside of the case, or just inside, and forms a second part of the complete magnetic circuit. The shield, in conventional ignition coils, may include multiple layers of silicon steel totaling a desired thickness (e.g., between about 0.40 mm and 1.40 mm). The well 12 is conventionally made of relatively thick steel (e.g., 2.0 mm thick) and is press fit into the engine head 14, as shown diagrammatically in FIG. 1. It is also known to use other materials for well 12, such as aluminum.

As described in the Background, a challenge for ignition system designers is to provide an ignition coil that provides positive feedback or some kind of tactile feel that the ignition coil is seated appropriately far enough into the spark plug well. Another problem relates to vibration-related failures due to the use of a rigid bracket to secure the ignition coil to the engine (or parts thereof). In addition, the bracket and bolt add cost and an assembly step, as well as increase the ignition coil's overall mass. In accordance with the present invention, a seal member portion of the ignition coil assembly and the spark plug well are modified to have cooperating features configured to longitudinally align the ignition coil assembly in the spark plug well. This provides a “snap-in” simplicity for installers, providing positive feedback, in a tactile sense, that the ignition coil assembly has been sufficiently inserted (i.e., correctly installed). The cooperating features may also be used to retain the ignition coil assembly, thereby eliminating the need for a mounting bracket and bolt. The seal member portion of the invention also acts as a vibration damper to isolate the ignition coil from harsh engine vibrations. This improved isolation reduces vibration-related failures (e.g., cracked brackets).

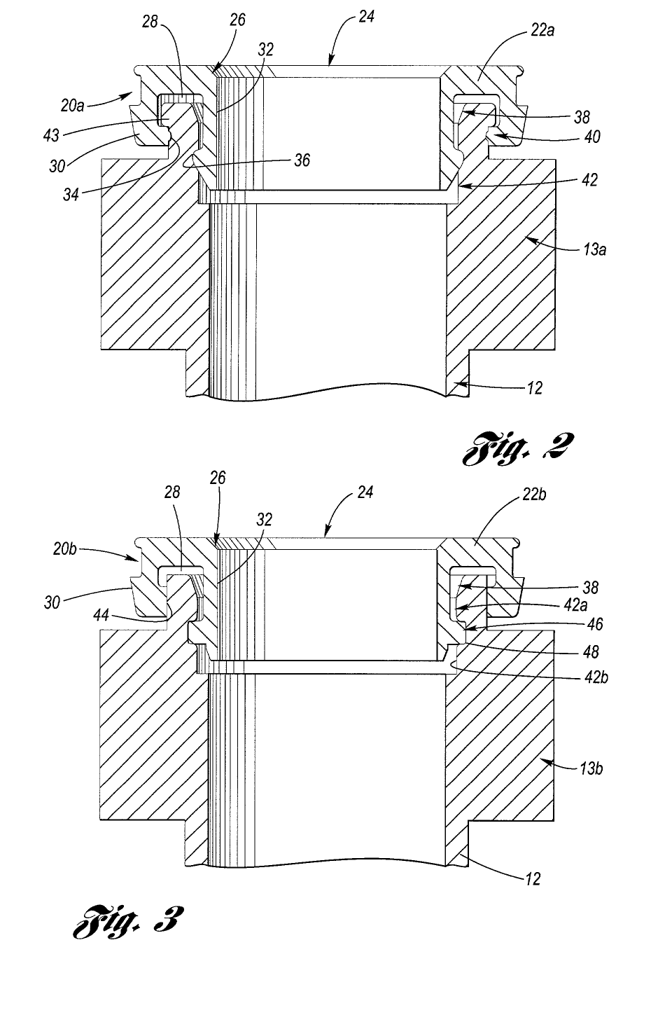

Referring to FIG. 2, a partial section view of a first preferred embodiment is shown and includes a seal member 20a and a cam cover 13a and/or spark plug well having cooperating features disposed on both member 20a and cover 13a. The cooperating features are configured to longitudinally align and position the ignition coil in the spark plug well in a predetermined relationship.

Seal member 20a includes a body portion 22a that is generally U-shaped in longitudinal cross-section (shown) and circular in radial cross section (not shown). Body portion 22a is circumferentially extending and is shaped so as to define a central through-bore 24 having a taper 26 at an opening thereof. The U-shaped body portion 22a defines a circumferentially-extending channel 28 with a first leg 30, and an inner wall 32. Outer leg 30 includes a circumferentially-extending inwardly radially projecting rib 34, while inner wall 32 includes, on an outside surface thereof, a circumferentially-extending radially outwardly projecting rib 36.

With continued reference to FIG. 2, cam cover 13a includes an opening (for insertion of ignition coil 11) having a circumferentially-extending radially inwardly guiding taper 38 disposed on an annular projection from the cam cover, hereinafter “lip.” Cam cover 13a also has a groove 40 on an outside diameter (OD) portion of the lip. The spark plug well 12 has an inside diameter (ID), substantially radially constant portion 42 extending from taper 38 to a radial step.

The overall outside diameter of rib 36 is selected so as to be slightly greater than the inside diameter of portion 42 of spark plug well 12, so as to establish interference therebetween. The overall outside diameter of groove 40 is slightly greater than the inside diameter of groove 34. This is again to establish a small amount of interference. Groove 40 represents an undercut groove 40 since it has a reduced diameter (radially) relative to the uppermost portion 43 of the lip of the cam cover. Seal member 20a may be formed from a suitable material having relatively high resistance to deformation when subjected to heat and load. However, it is desirable that seal member 20a be formed of a material having at least a predetermined amount of elastic deformation capability. This capability is to allow flexure of leg 30 when seal member 20a is inserted (with the remainder of ignition coil 11) into the spark plug well 12. In one embodiment, the seal member 20a may be formed of silicone rubber or thermoplastic rubber.

In operation, the seal member 20a is attached to the remainder of ignition coil 11. This is shown in phantom line format in FIG. 3. Taper 38 guides the inner wall 32 into the spark plug well. The rib 34 first engages an outside surface of feature 43 of the cam cover lip, and flexes slightly, as permitted by the U-shape structure. When the entire ignition coil 11 has been inserted far enough, rib 34 “snaps” down and into place in groove 40. The cooperating features described ensure the ignition coil is installed to the proper height.

In an alternate embodiment, the interference is sufficiently controlled so that the cooperating features provide a retention function (i.e., holding the coil assembly to the engine). In one embodiment, a stack up tolerance, due to control of the interference among other things, was about ±0.3 mm (taken longitudinally relative to axis “A”).

FIG. 3 is a partial section view (taken longitudinally) of a second embodiment according to the invention. A second seal member 20b and cam cover 13b having cooperating features configured to longitudinally align the ignition coil 11 in the spark plug well 12. Seal member 20b includes a body portion 22b that is generally U-shaped in longitudinal cross-section (shown) and circular in radial cross-section (not shown). Body portion 22b is circumferentially-extending and is shaped so as to define a central through-bore 24. Seal member 20b includes an opening having a circumferentially-extending radially inwardly guiding taper 26. The U-shaped body portion 22b is further shaped so as to define a circumferentially-extending channel 28 having an outer leg 30, and an inner wall 32. Outer leg 30, however, does not contain a rib 34 (as in the embodiment of FIG. 2), but rather includes an axially extending, inwardly facing surface configured to engage an outer diameter surface 44 of cam cover 13b.

Cam cover 13b includes an opening (for insertion of ignition coil 11) having a circumferentially-extending radially inwardly guiding taper 38 disposed on the cam cover lip. Cam cover 13b also includes a first land portion 42a and a second land portion 42b, each having substantially the same diameter as illustrated. In the embodiment shown in FIG. 3, however, cam cover 13b further includes an undercut groove portion 46 configured to mate with a corresponding circumferentially-extending radially outwardly projecting rib 48 of seal member 20b. The undercut groove portion 46 extends from land portion 42a and 42b and is radially enlarged relative to both.

The overall outside diameter of rib 48 is selected so as to be slightly greater than the inside diameter of undercut groove portion 46, so as to establish interference therebetween. The overall inside diameter of first land portion 42a is slightly less than the outside diameter of rib 48, again to establish a small amount of interference, and thereby function to retain the seal member 20b, and thus the entire ignition coil 11, in a desired position in spark plug well 12.

As with seal member 20a, seal member 20b may be formed from any suitable material having a relatively high resistance to deformation when subjected to heat and load. However, it is desirable that seal member 20b be formed of a material having at least a predetermined amount of elastic deformation capability. This capability is to allow flexure of leg 30 when seal member 20b is inserted (with the remainder of ignition coil 11) into the spark plug well 12. In one embodiment, the seal member 20b may be formed of silicone rubber or thermoplastic rubber.

In operation, the seal member 20b is attached to the remainder of ignition coil 11 (best shown in FIG. 3). The taper 38 guides rib 48 to first land portion 42a (i.e., the inside diameter of the cam cover lip). During this first phase, there is a small amount of compression and flexure of inner wall 32. When the entire ignition coil has been inserted into the spark plug well 12 far enough, rib 48 “snaps” down and into place in undercut groove 46. The cooperating features described ensure that the ignition coil 11 is installed to the proper height.

As with the embodiment of FIG. 2, the interference, in an alternate embodiment, is sufficiently controlled so that the cooperating features provide a retention function (i.e., holding the coil assembly to the engine). Again, as with the embodiment of FIG. 2, in one embodiment of FIG. 3, a stack up tolerance, due to control of the interference among other things, was about ±0.3 mm (taken longitudinally relative to axis “A”).

An ignition coil assembly in accordance with the present invention has several advantages. First, at the engine assembly plant, assembly of the ignition coil to the internal combustion engine is simplified, and may be as simple as a “push and click” operation by an installer. In addition, when designed so as to have a retention feature, the present invention eliminates the need for a bushing and/or bracket and/or bolt. This reduces the cost and the mass of the ignition coil. For example, a plastic bracket may be about 6.0 grams, and a bushing about 5.5 grams.

In addition, the cam cover of an internal combustion engine will not have to be formed having a mounting boss complementary with the conventional mounting bracket described in the Background. In addition, the present invention reduces vibration-related failures in the field because of the damping effect of the coil retention feature. Additionally, such reduced failures is also due to the fact that there is no longer a rigid bracket feature to break (i.e., under vibration).

FIG. 3 shows an exemplary ignition coil 11 that is suitable for use with the present invention. The seal member 20 is shown only in phantom line format and the spark plug well 12 have been omitted entirely for clarity. The ignition coil 11, while suitable, is exemplary only and not limiting in nature. Other variations are suitable for use in the present invention. As is generally known as background, ignition coil 11 may be coupled to, for example, an ignition system 112, which contains primary energization circuitry for controlling the charging and discharging of ignition coil 11. Further, also as is well known, the relatively high voltage produced by ignition coil 11 is provided to spark plug 15 (shown in phantom line format) for producing a spark across a spark gap thereof, which may be employed to initiate combustion in a combustion chamber of an engine. Ignition system 112 and spark plug 15 perform conventional functions well known to those of ordinary skill in the art.

Ignition coil 11 is adapted for installation to a conventional internal combustion engine through spark plug well 12 onto a high-voltage terminal of spark plug 15, which may be retained by a threaded engagement with a spark plug opening of engine head 14 (best shown in FIG. 1). Ignition coil 11 comprises in-effect a substantially slender high voltage transformer including substantially, coaxially arranged primary and secondary windings and a high permeability magnetic central core.

Ignition coil 11, as illustrated, may include a central core 116, a first magnet 118, a second magnet 120, a primary winding 124, a first epoxy potting material layer 126, a secondary winding spool 128, a secondary winding 130, a second epoxy potting material layer 132, a case 134, a low-voltage (LV) connector body 138, and a high-voltage (HV) connector assembly 140.

Central core 116 may be elongated, having a main, longitudinal axis “A” associated therewith. Core 116 includes an upper, first end 142, and a lower, second end 144. For example, core 116 may be a conventional core known to those of ordinary skill in the art. Core 116 comprises magnetically permeable material, for example, a plurality of silicon steel laminations, or, insulated iron particles compression molded to a desired shape, as known. As illustrated, core 116, in a preferred embodiment, takes a generally cylindrical shape (which is a generally circular shape in radial cross-section).

Magnets 118 and 120 may be included in ignition coil 11 as part of the magnetic circuit, and provide a magnetic bias for improved performance. The construction of magnets such as magnets 118 and 120, as well as their use and effect on performance, is well understood by those of ordinary skill in the art. It should be understood that magnets 118 and 120 are optional in ignition coil 11, and may be omitted, albeit with a reduced level of performance, which may be acceptable, depending on performance requirements.

Primary winding 124 may conventionally be wound directly onto central core 116 (e.g., when central core 116 is compression molded insulated iron particles), or may be wound on a primary winding spool (not shown) when core 116 comprises steal laminations. Primary winding 124 includes first and second ends and is configured to carry a primary current I for charging coil 11 upon control of ignition system 112. Winding 124 may be implemented using known approaches and conventional materials.

Layers 126 and 132 comprise epoxy potting material. The potting material 124 may be introduced into potting channels defined (i) between primary winding 124 and secondary winding spool 128, and, (ii) between secondary winding 130 and case 134. The potting channels are filled with potting material, in the illustrated embodiment, up to approximately the level designated “L”. The potting material performs the function of electrical insulation and, provides protection from environmental factors which may be encountered during the service life of ignition coil 11. There are a number of suitable epoxy potting materials well known to those of ordinary skill in the art.

Secondary winding spool 128 is configured to receive and retain secondary winding 130. Spool 128 is disposed adjacent to and radially outwardly of the central components comprising core 116, primary winding 124, and epoxy potting layer 126, and, preferably, is in coaxial relationship therewith. Spool 128 may comprise any one of a number of conventional spool configurations known to those of ordinary skill in the art. In the illustrated embodiment, spool 128 is configured to receive one continuous secondary winding (e.g., progressive winding), as is known. However, it should be understood that other configurations may be employed, such as, for example only, a configuration adapted for use with a segmented winding strategy (e.g., a spool of the type having a plurality of axially spaced ribs forming a plurality of channels therebetween for accepting windings) as known.

The depth of the secondary winding in the illustrated embodiment decreases from the top of spool 128 (i.e., near the upper end 142 of core 116), to the other end of spool 128 (i.e., near the lower end 144) by way of a progressive gradual flare of the spool body. The result of the flare or taper is to increase the radial distance (i.e., taken with respect to axis “A”) between primary winding 124 and secondary winding 130, progressively, from the top to the bottom. As is known in the art, the voltage gradient in the axial direction, which increases toward the spark plug end (i.e., high voltage end) of the secondary winding, may require increased dielectric insulation between the secondary and primary windings, and, may be provided for by way of the progressively increased separation between the secondary and primary windings.

Spool 128 is formed generally of electrical insulating material having properties suitable for use in a relatively high temperature environment. For example, spool 128 may comprise plastic material such as polybutylene terephthalate (PBT) thermoplastic polyester. It should be understood that there are a variety of alternative materials which may be used for spool 128 known to those of ordinary skill in the ignition art, the foregoing being exemplary only and not limiting in nature.

Spool 128 may further include a first annular feature 148 and a second annular feature 150 formed at axially opposite ends thereof. Features 148, and 150 may be configured so as to engage an inner surface of case 134 to locate, align, and center the spool 128 in the cavity of case 134.

In addition, the body portion of spool 128 tapers on a lower end thereof to a reduced diameter, generally cylindrical outer surface sized to provide an interference fit with respect to a corresponding through-aperture at the lower end of case 134. In addition, the spool body includes a blind bore or well at the spark plug end configured in size and shape to accommodate the size and shape of HV connector assembly 140. In connection with this function, spool 128 may be formed having an electrically conductive (i.e., metal) high-voltage (HV) terminal 152 disposed therein configured to connect a high voltage lead of secondary winding 130 to the HV connector assembly 140.

Secondary winding 130, as described above, is wound on spool 128, and includes a low voltage end and a high voltage end. The low voltage end may be connected to ground by way of a ground connection through LV connector body 138 in a manner known to those of ordinary skill in the art. The high voltage end is connected to the above-described (HV) terminal 152 for electrically connecting the high voltage generated by secondary winding 130 to HV connector assembly 140 for firing spark plug 15. As known, an interruption of a primary current Iₚ through primary winding 124, as controlled by ignition system 112, is operative to produce a high voltage at the high voltage end of secondary winding 130. Winding 130 may be implemented using conventional approaches and material known to those of ordinary skill in the art.

Case 134 may include an inner, generally cylindrical surface 154, an outer surface 156, a first annular shoulder 158, a flange 160, an upper through-bore 162, and a lower through bore 164.

Inner surface 154 is configured in size to receive and retain the core 116/primary winding 124/spool 128/secondary winding 130 assembly. The inner surface 154 of case 134 may be slightly spaced from spool 128, particularly the annular spacing features 148, 150 thereof (as shown), or may engage the spacing features 148, 150.

Annular shoulder 158, and flange 160 are located near the lower, and upper ends of case 134, respectively. Shoulder 158 may be formed in size and shape to engage an inside diameter of spark plug well tube 12 for spacing and locating functions.

Bore 162 is configured in size and shape to receive the combined assembly of core 116/primary winding 124/spool 128/secondary winding 130. Case 134 is formed of electrical insulating material, and may comprise conventional materials known to those of ordinary skill in the art (e.g., the PBT thermoplastic polyester material referred to above).

Low voltage connector body 138 is configured to, among other things, electrically connect the first and second ends of primary winding 124 to an energization source, such as, the energization circuitry included in ignition system 112. Connector body 138 is generally formed of electrical insulating material, but also includes a plurality of electrically conductive output terminals 166 (e.g., pins for ground, primary winding leads, etc.). Terminals 166 are coupled electrically, internally through connector body 138, in a manner known to those of ordinary skill in the art, and are thereafter connected to various parts of coil 11, also in a manner generally know to those of ordinary skill in the art. Ignition system 112 may then control energization of the primary winding 124.

HV connector assembly 140 may include a spring contact 168 or the like, which is electrically coupled to HV terminal (which is in turn coupled to the high voltage lead of secondary winding 130) disposed in a blind bore portion formed in a lowermost end of spool 128. Contact spring 168 is configured to engage a high-voltage connector terminal of spark plug 15. This arrangement for coupling the high voltage developed by secondary winding 130 to plug 15 is exemplary only; a number of alternative connector arrangements, particularly spring-biased arrangements, are known in the art.

An ignition apparatus in accordance with the present invention includes cooperating features disposed on a seal member thereof, as well as a cam cover/spark plug well in which the ignition coil is inserted. The features are configured, among other things, to longitudinally align the ignition coil in the spark plug well in a predetermined relationship. The cooperating features provide a tactile feel so that the ignition coil will “snap” into place when inserted to the proper longitudinal distance in the spark plug well. This improves the engine assembly process, and makes it more robust. In a preferred embodiment, the invention further provides a retention feature, thereby eliminating the need for a bracket and bolt to retain the ignition coil in the well. This elimination of the bracket and bolt reduces material costs, mass of the product, as well as reduces labor costs, and eliminates an assembly step (lessens the time for manufacture). Moreover, the seal member, when used to retain the ignition coil to the engine, eliminates the conventional solid bracket, and thus acts as a vibration damper to isolate the ignition coil from harsh engine vibrations. Accordingly, the invention reduces vibration-related failures during its service life because of the damping effect of the coil retention feature, and because there is no rigid bracket feature to break.

1. An ignition coil assembly having a main axis and configured for insertion in a spark plug well associated with an internal combustion engine comprising:
a transformer portion for generating a spark voltage on a connector at a first end of said coil; and
a seal member at a second end of said coil opposite said first end, said seal member and said engine having cooperating features configured to longitudinally align said coil in said well in a predetermined relationship.

2. The ignition coil assembly of claim 1 wherein said spark plug well extends from a cam cover and includes an opening for insertion of said coil assembly and wherein a first one of said cooperating features comprises, on an inside diameter of an upper portion of said cover, an undercut groove portion, a second one of said cooperating features comprises, on an outside diameter of said seal, a rib complementary with said undercut groove portion.

3. The ignition coil assembly of claim 2 wherein said undercut groove portion and said rib are circumferentially-extending.

4. The ignition coil assembly of claim 2 wherein said opening comprises a circumferentially-extending radially inwardly guiding taper, and a land portion extending from said taper, said undercut groove portion extending from said land portion and being radially enlarged relative thereto.

5. The ignition coil assembly of claim 4 wherein said rib is radially enlarged relative to outside surface areas immediately surrounding said rib.

6. The ignition coil assembly of claim 4 wherein said cooperating features provide a tactile feel characteristic when said coil assembly is inserted in said well such that said rib moves over said land and is seated in said undercut groove portion.

7. The ignition coil assembly of claim 4 wherein said rib has a diameter larger than that of said land.

8. The ignition coil assembly of claim 1 wherein said well extends from a cam cover and includes an opening for insertion of said coil assembly, wherein a first one of said cooperating features comprises, on an outside diameter of a lip portion of said cover proximate said opening, an undercut groove portion, a second one of said cooperating features comprises, on said seal member, a rib complementary with said undercut groove portion.

9. The ignition coil assembly of claim 8 wherein said rib has a first diameter that is less than a second diameter of said groove portion to thereby produce interference.

10. The ignition coil of claim 9 wherein said rib and said groove are circumferentially extending.

11. An ignition coil assembly configured for insertion in an opening of a spark plug well extending from a cam cover associated with an internal combustion engine comprising:
a central core having a main axis;
primary and secondary windings disposed outwardly of said central core forming a high voltage transformer, an end of said secondary winding being connected to a connector at a first end of said ignition coil assembly; and
a seal member disposed outwardly of said high-voltage transformer and proximate a second end of said ignition coil assembly opposite said first end, wherein said seal member and said cam cover have cooperating features configured to longitudinally align said ignition coil assembly in said spark plug well in a predetermined relationship when inserted therein.
